(19) United States
(12) Patent Application Publication
(10) Pub. No.: US 2024/0403340 A1
(43) Pub. Date: Dec. 5, 2024

(54) HUMAN-IN -LOOP ARTIFICIAL INTELLIGENCE CLASSIFICATION

(71) Applicant: Quickcode.ai, Inc., McLean, VA (US)

(72) Inventors: Daniel Boxler, Longmont, CO (US); Eoin Crafferty, Denver, PA (US); Shannon Hynds, McLean, VA (US); Herbert Klopfenstein, Colorado Springs, CO (US); Joseph Morales, Colorado Springs, CO (US); Ross Nordstrom, Colorado Springs, CO (US)

(73) Assignee: Quickcode.ai, Inc., McLean, VA (US)

(21) Appl. No.: 18/673,800

(22) Filed: May 24, 2024

Related U.S. Application Data
(60) Provisional application No. 63/505,315, filed on May 31, 2023.

(51) Int. Cl. G06F 16/33; G06F 16/338; G06F 16/35

(52) U.S. Cl. CPC G06F 16/3344; G06F 16/3347; G06F 16/338; G06F 16/353

(57) ABSTRACT

Aspects of the present disclosure relate to the use of natural language processing models in classifying objects in a hierarchical classification system. Methods, systems, and computer program products for classifying an object in a classification system are provided.

### CROSS REFERENCE TO RELATED APPLICATIONS

The present application claims the benefit of priority to U.S. Provisional Application Ser. No. 63/505,315, filed on May 31, 2023, which is incorporated herein by reference in its entirety.

### TECHNICAL FIELD

Aspects of the present disclosure relate to the fields of machine learning and natural language processing. In particular, the present disclosure relates to the use of natural language processing models in classifying objects in a hierarchical classification system.

BACKGROUND

Generally, every commodity exported from and imported to a country must be classified using the World Customs Organization (WCO) Harmonized Commodity Description and Coding System, also known as the Harmonized System (HS) of tariff nomenclature, as potentially extended by the subject country. In the United States, for example, there are separate HS extensions for imports¹ and exports.² In order to classify a commodity, customs brokers (or their agents) typically begin with a detailed description of the commodity including what it's made of and its use. The customs brokers then consult a variety of data sources including the text and legal notes of the relevant HS schedule for their country for import or export, the WCO General Rules of Interpretation, the WCO Explanatory Notes, rulings and court cases that may have been previously issued on similar products, and existing documented imports/exports of similar products, which may be publicly available (e.g., bill of lading data). By synthesizing all this information, the customs brokers attempt to determine where the commodity fits in the HS schedule.

The HS schedule is an internationally standardized system of names and numbers to classify traded products.³ The HS schedule came into effect in 1988 and has since been developed and maintained by the WCO (formerly the Customs Co-operation Council), an independent intergovernmental organization based in Brussels, Belgium. It is used by over 200 WCO member countries and economies as a basis for their Customs tariffs and for the collection of international trade statistics as well as many other purposes. The HS code consists of 6-digits. The first two digits designate the Chapter wherein headings and subheadings appear. The second two digits designate the position of the heading in the Chapter. The last two digits designate the position of the subheading in the heading. HS code 1006.30, for example, indicates Chapter 10 (Cereals), heading 10.06 (Rice), and subheading 1006.30 (Semi-milled or wholly milled rice, whether or not polished or glazed). In addition to the HS codes and commodity descriptions, each Section and Chapter of the HS is prefaced by Legal Notes, which are designed to clarify the proper classification of goods.

A customs broker typically begins their review at the highest level of the HS code searching for a Chapter which accurately describes an object or commodity. The broker then searches deeper into the HS code for the correct heading and subheading until they have a complete classification. To identify the chapter, heading, and subheading, the broker may use a key word search based on a description of the object he created. The keyword search, however, may miss important sections of the HS code as the search is limited to an object description generated by the broker. For example, if a broker searches for “titleist 5 iron,” a type of golf club, the search may not result in the correct Chapter 95 of the HS code titled “Toys, games and sports requisites; parts and accessories thereof.”

Artificial Intelligence (AI) models may be useful when classifying objects. Companies such as 3CE/Avalara, Thomson Reuters One-Source Zonos, Archlynk, and Transiteo offer such tools. These existing products, however, unsuccessfully utilize the potential of AI models. Some Al models in existing products require training data comprising a history of correct classifications for similar, if not the same, products. These models, however, are limited in scope and cannot classify new or even slightly different products. Other AI models may use inaccurate shipping data for training, thereby resulting in a wildly inaccurate model. Another product may use an “expert system” designed by human experts. The human experts may create a list of questions for a user, such as “what is the material of the object” and “what is the use of the object,” to generate a list of possible classifications for the object. These “expert systems,” however, are not true AI models and instead rely on a group of human experts to maintain a list of questions for guiding users to correct classifications.

### SUMMARY

While useful, there are multiple challenges that commonly arise when implementing existing AI models for classifying objects in a hierarchical classification system.

For example, the Harmonized Tariff Schedule of the United States (HTSUS) classification system is very complex, with thousands of product categories and subcategories, each with their own set of rules and regulations. This complexity makes it difficult for AI models to accurately classify products without making mistakes.

For another example, AI models require a large amount of high-quality data for training, which can be difficult to obtain for HS classification. Data quality and accuracy are critical for training accurate and reliable models, but the data available for HS classification is often incomplete, inconsistent, and not standardized.

For another example, the HTSUS classification system requires interpretation of technical terms and language, which can be difficult for AI models to understand without the proper context or background knowledge.

For another, example, importers must comply with various regulatory requirements, and it can be challenging to develop AI models that are able to take these regulations into account when classifying products.

Overall, the development of AI-based solutions for HS classification requires significant investment in data, expertise, and technology. While progress has been made in this area, there is still a long way to go before fully automated solutions can replace the human expertise required for accurate HS classification.

Aspects of the present disclosure include a method for classifying an object. The method includes obtaining a query, wherein the query comprises a text describing the object. The method includes transforming, using a first natural language processing model, the query into a query embedding vector. The method includes calculating a set of similarity scores, wherein each similarity score in the set of similarity scores corresponds to a degree of similarity between the query embedding vector and an embedding vector in a set of embedding vectors, wherein each embedding vector in the set of embedding vectors is associated with a location in a hierarchy classification system and a data source of a plurality of data sources. The method includes selecting one or more candidate embedding vectors from the set of embedding vectors based on the calculated similarity scores. The method includes identifying a set of one or more candidate locations in the hierarchy classification system, wherein each of the one or more candidate locations is associated with at least one of the selected one or more candidate embedding vectors. The method includes generating an output comprising an indication of the identified one or more candidate locations in the hierarchy classification system. The method includes transmitting the output towards a user device.

According to another aspect, a method for classifying an object is provided. The method includes displaying a graphical user interface (GUI). The method includes submitting a query with the GUI, wherein the query comprises a text describing the object. The method includes obtaining a response to the query, the response comprising a first set of one or more candidate locations in a hierarchy classification system. The method includes displaying a first candidate locations section in the GUI, the first candidate locations section identifying the first set of one or more candidate locations in the hierarchy classification system. The method includes displaying an additional description section in the GUI, the additional description section identifying an additional description of the object based on the first set of one or more candidate locations. The method includes obtaining an indication of a selection of the additional description. The method includes displaying a second candidate locations section in the GUI, the second candidate locations section identifying a second set of one or more candidate locations in the hierarchy classification system based on the selection of the additional description. The method includes obtaining an indication of a selection of a candidate location in the second set of one or more candidate location, wherein the selected candidate location is a complete classification in the hierarchy classification section. The method includes displaying an additional information section in the GUI, the additional information section identifying additional information associated with the selected candidate location.

According to another aspect, a device is provided, wherein the device is adapted to perform any one of the methods described above.

According to yet another aspect, a computer program comprising instructions is provided, which when executed by processing circuity of a device, causes the device to perform any one of the methods described above.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 illustrates a block diagram, according to some embodiments.

FIG. 2 illustrates a device, according to some embodiments.

FIG. 3 is a flowchart illustrating a process, according to some embodiments.

FIG. 4 is a flowchart illustrating a process, according to some embodiments.

FIG. 5 is a flowchart illustrating a process, according to some embodiments.

FIGS. 6-12 illustrates a graphical user interface, according to some embodiments.

FIG. 13 is a method, according to some embodiments.

FIG. 14 is a method, according to some embodiments.

### DETAILED DESCRIPTION

Aspects of the present disclosure relate to HS classification using AI-based models. In particular, large language models (LLMs) may be used to improve the state of AI-based HS classification. While LLM-based solutions are unlikely to completely replace humans, they can be used to create human-in-the-loop AI solutions that bring together the expertise of human classifiers and the computer power of AI. LLMs may be used to improve the contextual understanding of technical terms and language used in the HS classification system. By training an LLM on a large corpus of technical documents, it is possible to develop models that have a deep understanding of the specific language used in the HS classification system.

LLMs trained on the Customs Rulings Database (CROSS), Bill of Lading data (BOL), International Organization for Standardization (ISO) standards, Chemical Abstracts Service (CAS) numbers, and other product databases can be used to identify similar products with similar attributes. This can help the human classifiers identify the correct HS classification code. By training an LLM on a large corpus of annotated data, it is possible to develop models that can identify and correct errors in the classification of products.

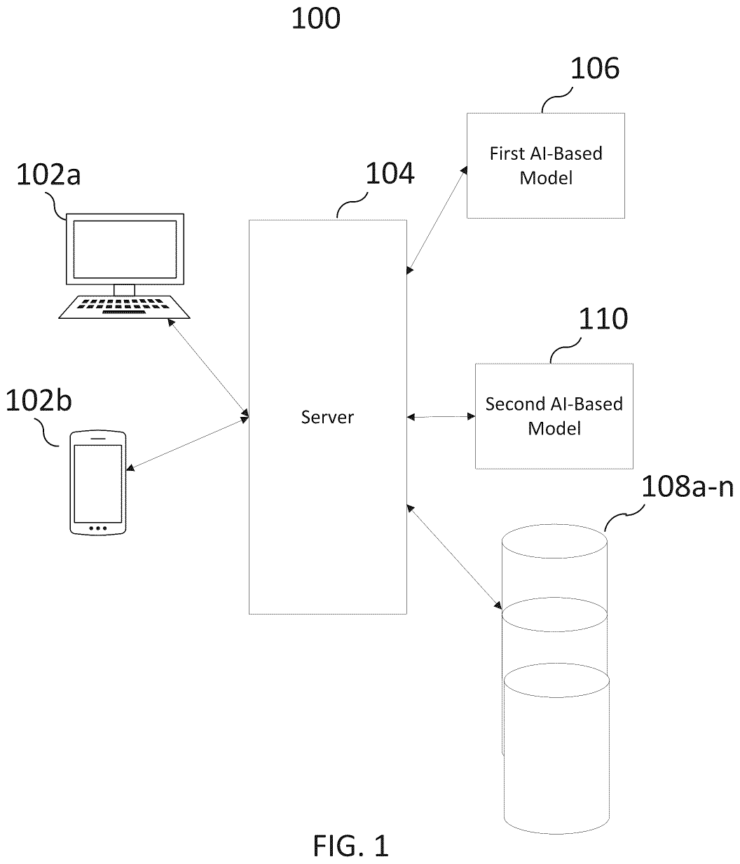

FIG. 1 is a block diagram, according to some embodiments. In some embodiments, FIG. 1 illustrates Architecture 100 for implementing a human-in-the-loop AI solution for classifying an object in a hierarchical classification system. Architecture 100 allows an HS classification specialist, one or more users, to quickly find the correct classification code for an object using a graphical user interface (GUI) and assisted by artificial intelligence (AI). The user may use Architecture 100 to classify an object in the US import market (the HTSUS schedule) or according to any other international import/export market.

The users operating User Devices 102A-B may transmit a query towards Server 104. The query may include a description of an object the user wishes to classify. User Devices 102A-B may be an electronic computing device, such as a mobile device, laptop, computer, desktop, tablet, and the like, capable of communication with one or more other devices through a network such as the Internet. In some embodiments, User Devices 102A-B may transmit a query towards Server 104 via a web or mobile application. The application may contain a graphical display, or GUI, that allows users to enter and transmit the query towards Server 104.

Server 104 may be communicatively coupled with First AI-Based Model 106, Second-Based AI Model 110, and one or more Data Sources 108a-n. In some embodiments, these components are co-located on the same device. In other embodiments, one or more of these components may be dispersed among one or more computing devices or servers, e.g., in a cloud-based and/or virtual environment. In some embodiments, Server 104 may be a physical device. Server 104 may include software for implementing the processes and flowcharts described here. In other embodiments, Server 104 may be virtualized and running on a virtual machine.

In some embodiments, Server 104 uses multiple complex algorithms to search Data Sources 108a-n for language that matches the description of the object to be classified. Data Sources 108a-n may include the text and legal notes from HTSUS, the text of the WCO Explanatory Notes and HS Schedule, and the text from US Customs Rulings. In some embodiments, Data Sources 108a-n may additionally include US International Trade Court opinions, WCO classification opinions, US bill of lading data, US Customs informed compliance publications, UK Classification Guides, and any other source of text that describes commodities and provides classification guidance.

In some embodiments, First AI-Based Model 106 may be a large language model (LLM). In some embodiments, First AI-Based Model 106 is a commercially available LLM, such as OpenAI's GPT LLM.

In some embodiments, prior to receiving a query from the users, Server 104 may use Second AI-Based Model 110 to prepare Data Sources 108a-n for searching. Second AI-Based Model 110 may comprise a large language model, such as Google's BERT. In some embodiments, the Second AI-Based Model 110 utilizes OpenSearch text search algorithms in order to identify similar text. Second AI-Based Model 110 may be used to transform the text of Data Sources 108a-n into a set of embedding vectors. Each embedding vector in the set of embedding vectors is associated with a location in a hierarchy classification system. For example, Second AI-Based Model 110 may generate two embedding vectors for a US Import & Export guidance document, one embedding vector for the title and a second embedding vector for the body of text. Both embedding vectors may be associated with the HS code discussed in the guidance document. Later in the classification process, Second AI-Based Model 110 may perform AI-based neural search methods that use an open-source LLM to search for similarity of meaning between an object description and the language of Data Sources 108a-n.

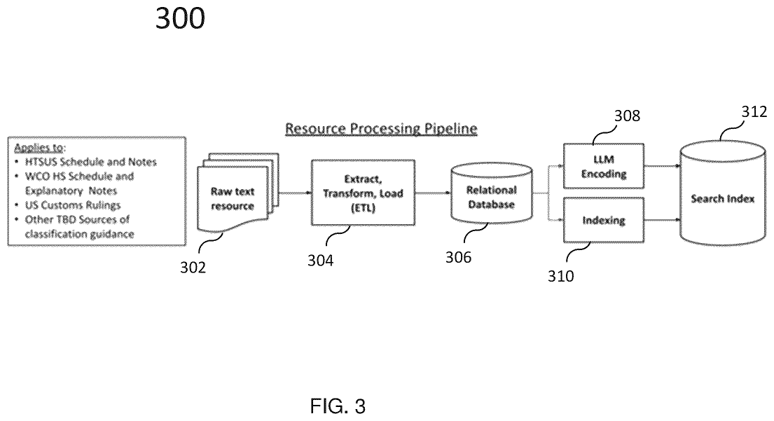

FIG. 3 is a flow diagram, according to some embodiments. In some embodiments, FIG. 3 illustrates logical flow 300 for preparing Data Sources 108a-n for searching. In some embodiments, Server 104 performs the steps of logic flow 300. Logical flow 300 may begin with block 302.

At 302, Server 104 may obtain multiple sources of text for classification including the HTSUS schedule and legal notes, WCO explanatory and legal notes, U.S. Customs and Border Protection (CBP) Cross Rulings, and additional resources. All these sources contain text descriptions associated with HS (or HTSUS) codes. Data Sources 108a-n comprise the obtained sources of text.

At 304, Server 104 may parse the resources, extract relevant information, and organize and store it in a relational database in a form that is easily consumable the users.

At 306, Server 104 generates a relational database to provide organized, searchable text resources of Data Sources 108a-n, to the user to help them during the classification process. The user may view the database via a GUI shown on User Devices 102A-B.

At 308, Server 104 may index Data Sources 108a-n, into OpenSearch search indices in two ways. Server 104 may use classic OpenSearch indexing techniques (tokenizing, stemming, ect.) and/or LLM encoding (vectorization) to support neural search by the classification AI. The LLM encoding may be performed by the Second AI-Based Model 110 and may transform the text of Data Sources 108a-n into a set of embedding vectors.

At 310, Server 104 may index multiple aggregations of the text. For example, in the case of the HTSUS schedule, Server 104 may produce a short description that includes the text associated with a specific code, and a full description that includes the text of all the ancestors of the code. The ancestors of the code being the nodes higher up in the HS/HTSUS hierarchy.

At 312, Server 104 may optimized Data Sources 102A-B for searching by both the user and Second AI-Based Model 110.

Referring back to FIG. 1, the users may begin the classification process by typing or pasting an object (e.g., commodity) description in a text box on User Devices 102A-B. The text box may be included as part of a GUI provided by Architecture 100. In some embodiments, the object description may be automatically generated using file import, automatic import from email, image recognition, optical character recognition, and API integration. For example, the object description may be obtained from an invoice or other document accompanying the import. User Devices 102A-B may generate a query including the object description and transmit the query towards Server 104. After receiving the query, Server 104 may begin the classification process.

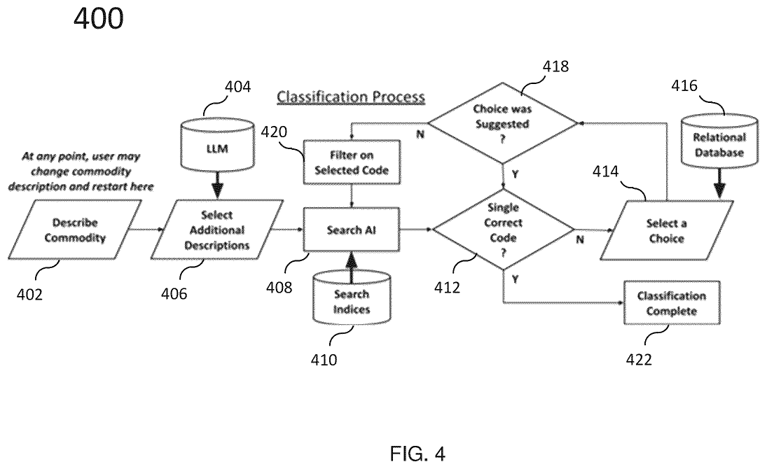

FIG. 4 is a flow diagram, according to some embodiments. In some embodiments, FIG. 4 illustrates logical flow 400 for classifying the object using a human-in-the-loop AI solution. In some embodiments, Server 104 performs the steps of logic flow 400. Logical flow 400 may begin with block 402.

At 402, Server 104 receives the object description from User Devices 102A-B. In some embodiments, the description may be derived from a commercial invoice, product webpage, bill of lading, etc. In some embodiments, a user may import and partially classify commodities in bulk using a spreadsheet or comma-separated-values (CSV) file.

At 404, Server 104 may use First AI-Based Model 106 to enhance the object description. Server 104 may use the object description provided by the user to query First AI-Based Model 106 with specific prompts designed to elicit additional descriptions of the object. First AI-Based Model 106 may be embodied as a Large Language Model (LLM) such as GPT 3.5, aka ChatGPT (GPT). First AI-Based Model 106 may be trained on very large corpora of text allowing it to recognize brand names and other nuances which may be present in the user's object description and is able to provide additional relevant information about the object.

In some embodiments, Server 104 may use one of the following prompts to elicit additional descriptions from First AI-Based Model 106:

a. Can you describe what the following is in 5 words or less?

b. Can you give me a 3 bullet summary of descriptions of what the following is, each in 3 words?

c. What category does the following thing belong to, in 3 words or less?

At 406, Sever 104 may generate, and then transmit towards User Devices 102A-B, an output with one or more of the descriptions generated by First AI-Based model 106. The one or more additional descriptions may be presented to the users via the GUI. The users may select any one of the one or more additional descriptions if they believe it accurately describes the object. The selected additional description will be use by Server 104 for generating an enhanced description for the object.

At 408, Server 104 uses the object description, and potentially the enhanced description, to search for classification codes in the hierarchical classification system.

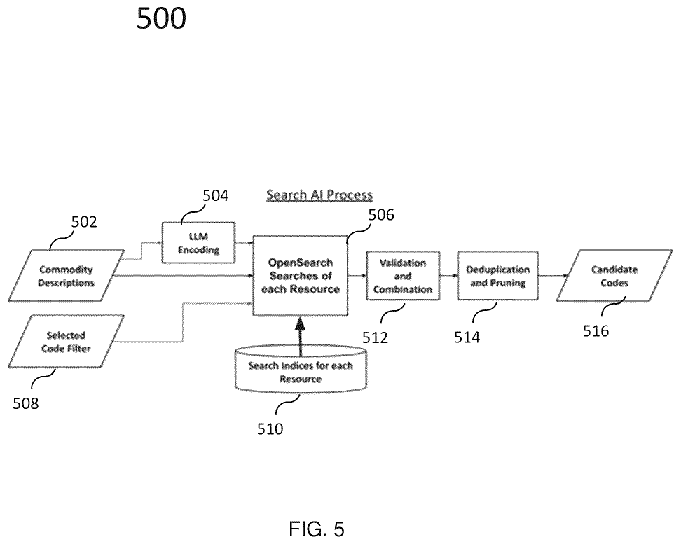

FIG. 5 is a flow diagram, according to some embodiments. In some embodiments, FIG. 5 illustrates logical flow 500 for searching for classification codes in the hierarchical classification system. In some embodiments, Server 104 performs the steps of logic flow 500. Logical flow 500 may begin with block 502.

At 502, Server 104 may obtain the user-provided description and/or the enhanced description. In embodiments where the user has selected one or more of the provided additional descriptions, Server 104 will use the enhanced description of the object for searching. The enhanced description comprising the original user provided description and the selected additional descriptions. In embodiments where the user has not selected an additional description, Server 104 will only use the user provided description for searching.

At 504, Server 104 may transform the user-provided description and/or the enhanced description (“object description”) using Second AI-Based Model 110 into a query embedding vector. In some embodiments, Server 104 may use one or more of the following techniques to encode the object description:

a. Classic OpenSearch indexing techniques (tokenizing, stemming, et cetera), and

b. Large Language Model (LLM) encoding (vectorization).

At 506, Server 104 may search the text of Data Sources 108a-n for similarities with the object description. In some embodiments, Server 104 may use Second AI-Based Model 110 to search Data Sources 108a-n. Second AI-Based Model 106 may search for similarities between the query embedding vector (object description) and the set of embedding vectors (Data Sources 108a-n). Server 104 may additionally perform a key word search between the object description and the text of Data Sources 108a-n.

At 508, Server 104 may filtered to a selected code, or section of the code, of the hierarchal classification system. For example, the user may indicate via the GUI to search specific sections of the classification systems. In such embodiments, Server 104 may limit the search to the relevant sections.

Back to 506, the search may result in a set of similarity scores. Each similarity score in the set of similarity scores corresponds to a degree of similarity between the query embedding vector (object description) and an embedding vector in a set of embedding vectors (Data Sources 108a-n). Each embedding vector in the set of embedding vectors is associated with a location in a hierarchy classification system and a resource of Data Sources 108a-n. For example, a location in a hierarchy classification system may be associated with a complete candidate code and/or partial HS codes (2, 4, 6, 8, or 10 digits). The similarity score may indicate a degree to which the text associated with the code in a resource matches the user-provided description.

In some embodiments, Data Sources 108a-n may include human expert curated examples of commodities that are classified in each chapter or section of the HS system. The similarity scores may be computed using the human expert curated examples.

At 510, Server 104 may search the indices of each resources of Data Sources 108a-n. Server 104 may perform the search using a key word search and/or calculating a degree of similarity between the query embedding vector (object description) and an embedding vector of the indices.

At 512, Server 104 may validate and combine the similarity scores in a variety of ways including using trained machine learning models. In some embodiments, classic machine learning may be used to combine findings from various data sources. Here, candidate classifications and scores for each finding for each data source may be treated as individual features and a variety of classic machine learning algorithms may then be employed to determine the optimum way to combine these features to produce the most accurate classifications.

At 514, Server 104 may combine duplicate results and prune the list of candidate codes to only return the most relevant results. In some embodiments, the results and relevance scores may be combined using empirically-derived algorithms that account for the similarity of the language meaning, the specificity of the results, and similar results received from multiple sources. Codes and scores are compared and adjusted for redundancy including not only duplicate codes but ancestor-descendant relationships. Candidate codes with poor (low) scores relative to others are pruned from the set. The resulting set of codes are expected to be the most likely HS codes under which the object may be classified, and their relevance score represents how likely the code is to be the correct classification.

In some embodiments, Server 104 may also produce a confidence score. For each commodity being classified, the degree to which a classification may progress without human intervention may be governed by comparing the highest confidence choice at each decision step to confidence thresholds. For example, Server 104 may select between partial codes 9508 and 9505 when classifying a commodity. This selection may be associated with a confidence score indicating how sure Server 104 is that the selection is correct. If the confidence score is below a confidence threshold, Server 104 may prompt a user for input.

The confidence threshold may be based on an accompanying risk score for each decision point in the classification that accounts for the differences in compliance requirements including tariff, additional tariff, additional partner government agency (PGA) requirements, and relevant antidumping/countervailing (AD/CVD) cases. A lower risk decision may have similar or identical requirements in each of these areas. For example, selecting between a first code and second code may be low risk when the regulations are similar between the two codes. A higher risk decision may have differences in these areas, for example a different tariff meaning that an incorrect classification decision could result in the importer paying too little (or too much) tariff. A user may adjust thresholds based on confidence and risk scores that reflect their individual risk tolerance. A lower threshold may result in Server 104 progressing classifications further automatically with an accompanying increase in the risk of an incorrect decision. A higher threshold may reduce the risk of an incorrect decision at the price of less automatic classification progress.

At 516, Server 104 generates a list of a locations in a hierarchy classification system, or a set of candidate codes, and transmits the list to User Devices 102A-B.

Referring back to FIG. 4, at 408, Server 104 analyzes the set of candidate codes with the HTSUS schedule, or the relevant schedule, to determine the branches of the schedule that contain the candidate codes. Each branch point from the top of the schedule to each candidate code is examined to see if candidate codes exist in two or more branches from that point. Those branch points where all candidate codes are in the same branch (from that point) are presented to the user as assumptions. For example, if the search returned partial codes 9508 and 9505, Server 104 may determine that the codes contained in branch, or Chapter 95, of the HS code. Server 104 may then present Chapter 95 as an assumption. Those branch points with multiple branches containing candidate codes are presented to the user as a set of choices.

In some embodiments, prior to presenting the multiple branches to the user, Server 104 may evaluate the relevancy and appropriateness of the suggested classifications. Server 104 may perform the evaluation using Second AI-Based Model 110. To perform the evaluation, Server 104 may provide Model 110 with the candidate codes and the text from data sources used to identify the candidate codes. Server 104 may then ask Model 110 to evaluate the findings and recommend candidate codes which it determines are more likely to be correct and which candidate codes are more likely to be incorrect. The scores of the candidate codes may be adjusted accordingly prior to the branches and candidate codes being presented to the user.

In some embodiments, Server 104 may ask Model 110 to suggest additional classifications that may not have been present in the original findings. Here, Model 110 may be allowed to add additional candidate classifications that it encountered during its training.

At 410, Server 104 may search the indices of Data Sources 108a-n as part of the searching process. The search may be performed using the methods and processes described at 408.

At 412, Server 104 determines if there is a single candidate code remaining. If so, Server 104 proceeds to 422 with a complete classification. If there is not a single candidate code remaining, Server 104 may present the candidate codes to the user via a GUI.

At 414, the user may select one of the candidate codes. The GUI may additionally allow the user to view a relational database 416 which provides more information about each of the candidate code.

At 418, Server 104 determines if the user has selected one of the candidate codes. If so, Server 104 modifies the set of candidate codes based on the user's selection and returns to 412. For example, if the user selected Chapter 95 of the HS system, then Server 104 may update the set of candidate codes to include one or more of the headings under Chapter 95. If the user does not select one of the candidate codes, Server 104 may proceed to 420.

At 420, Server 104 may identify a candidate code to filter on and proceed back to 408 to perform the searching process again. In some embodiments, the filter may be provided by the user. For example, after viewing the candidate codes, the user may decide none of the candidate codes represent the object. Rather, the user believes Chapters 80-85 of the HS system may describe object. Here, Server 104 will perform the searching process again focusing on Chapters 80-85, the filtering code section.

Throughout 412-422, the text associated with the candidate codes presented to the user may consist primarily of the text found at the associated node in the schedule tree. For example, the choice of partial codes 9508 may consist of its HS description “Roundabouts, swings, shooting galleries, other fairground amusements, travelling circuses, travelling menageries and travelling theatres.” In some embodiments, the text presented to the user may be generated by an LLM such as GPT.

Based on the set of candidate code selected by Server 104, the results may be displayed to the user in different manners.

The candidate codes displayed to the user may be accompanied with an explainable AI. The explainable AI may illustrate to the user the reasoning as to why particular candidate codes were recommended. Each candidate code presented to the user may include a short LLM-generated summary of the findings along with a button to view more details. Clicking this button may activate a “fly-in” panel which includes the complete details from each data source that recommended the candidate code. Providing this information allows the user to very quickly judge whether the candidate code is appropriate and accept or reject it accordingly.

In some embodiments, Server 104 may identify multiple candidate codes. When multiple candidate codes exist, or when there is a single candidate code that is incomplete (10 digits are generally required for a complete code in HTSUS), resolution is required. In embodiments with an incomplete code, the candidate codes may be considered to consist of all the complete-code descendants of that incomplete code in the HS schedule tree. Because candidate codes have relevancy scores associated with them, the GUI may present choices to the user in relevancy order, with the most likely choice being the first. This may allow the user to identify the correct choice more quickly when they know it, and in the case where they are unsure, it allows them to be guided by the GUI to the most likely choice. By iteratively selecting the choice that most accurately describes the commodity, users narrow down candidate codes until they arrive at a single, complete code which is the correct classification. In some embodiments, the correct code will not be in the set of candidate codes provided by Server 104. Server 104 allows the user to complete the classification by selecting a choice that was not suggested.

When there are multiple candidate codes, Server 104 may find the lowest branch point that contains all the candidate codes and presents the user with a set of choices representing the branches at that point and the prompt “Select which one best describes the product”. The branches that contain candidate codes are presented to the user ordered by the relevancy scores of said codes. The remaining branches from that branch point may be presented by clicking “View More Options”. The user may select a choice which selects a branch: if the branch was one containing candidate codes, the candidate set is reduced to those codes; if the branch was under “View More Options”, the candidate set is reduced to the single code that specifies the selected branch.

In some embodiments, the user may see an incorrect assumption above the currently presented branch point and exercise their option to change it by clicking on the assumption. The GUI shows all the branches available at that point as choices and the user may select any of them. The candidate set is reduced to the single code that specifies the selected branch.

In some embodiments, the selected candidate codes comprises a single candidate code that is a complete code but that the user judges to be incorrect. In such embodiments, the user may change one of the assumptions or choices and Server 104 may produce a new set of candidate codes.

In some embodiments, Server 104 may identify to “Other” branch points. “Other” is the description of 23% of the nodes in the HTSUS schedule. “Other” means essentially “none of the above.” For the user, the GUI may assist them by explicitly stating all the cases that must be not true for the “Other” case to be true.

At 422, Server 104 and the user have arrived at a single, complete, and correct classification code.

When classification is complete (by elimination of all but one candidate HS code for example), the user is shown additional details that apply to that HS code including:

the rate of the tariff for the commodity under multiple circumstances,

additional temporary tariffs which may apply to the commodity,

tariff exclusions which may apply,

free trade agreements which may apply, and/or

partner government agency requirements (e.g. FDA) which may apply.

Server 104 may additionally present the user with one or more of the following

related documents:

a. legal notes from both local (HTSUS for US imports) and WCO schedule which refers to the code. Server 104 may automatically find and presents to the user every reference to the selected code in those notes (including its containing chapter, heading and subheading),

b. rulings and opinions from both the local government and WCO. Server 104 may automatically finds relevant rulings from US customs rulings, WCO and other government rulings and opinions, and

c. government classification guidance, for example US Informed Compliance publications and UK Classification guides. Server 104 may provide the user with relevant excerpts from these and other classification guidance publications.

In some embodiments, Server 104 maintains a user's set of classified commodities in a “Product Catalog”. When a user enters a new commodity, it may be a duplicate of, or similar to, or otherwise related to an existing product in the user's catalog. Server 104 may use vector similarity algorithms, LLMs, and traditional machine learning algorithms to detect and reduce duplicate entries and to aid in classification of new entries that are similar or related to existing entries.

Server 104 may produce and store several types of additional compliance data including additional tariffs, partner government agencies (PGA) requirements, and relevant antidumping and countervailing duties (AD/CVD) cases in the product catalog when the user completes a classification for a commodity. In some embodiments, the classification and additional compliance data sources are continuously monitored for changes or updates that may affect the completed classifications. When such changes are detected, Server 104 may alert the user and in some cases attempt to update the information in the product catalog automatically.

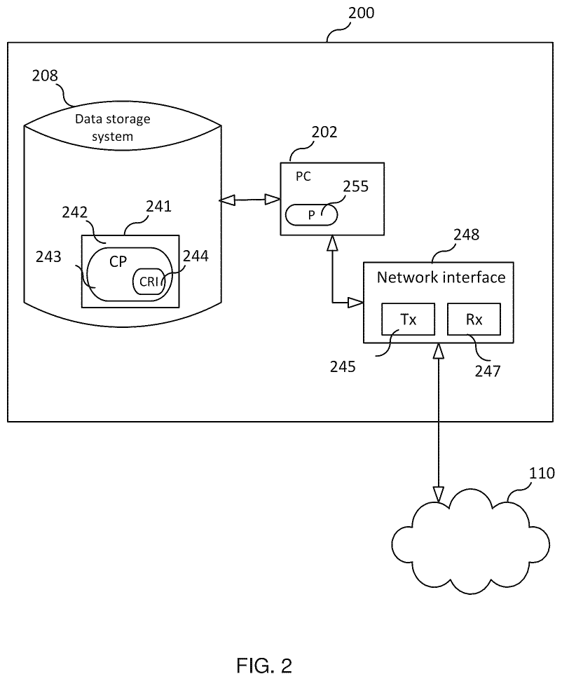

FIG. 2 is a block diagram of device 200 (e.g., User Devices 102A-B and/or Server 104), according to some embodiments. As shown in FIG. 2, device 200 may comprise: processing circuitry (PC) 202, which may include one or more processors (P) 255 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., computer device 200 may be a distributed computing apparatus); at least one network interface 248 (e.g., a physical interface or air interface) comprising a transmitter (Tx) 245 and a receiver (Rx) 247 for enabling device 200 to transmit data to and receive data from other nodes connected to a network 110 (e.g., an Internet Protocol (IP) network) to which network interface 248 is connected (physically or wirelessly) (e.g., network interface 248 may be coupled to an antenna arrangement comprising one or more antennas for enabling device 200 to wirelessly transmit/receive data); and a storage unit (a.k.a., “data storage system”) 208, which may include one or more non-volatile storage devices and/or one or more volatile storage devices. In embodiments where PC 202 includes a programmable processor, a computer readable storage medium (CRSM) 242 may be provided. CRSM 242 may store a computer program (CP) 243 comprising computer readable instructions (CRI) 244. CRSM 242 may be a non-transitory computer readable medium, such as, magnetic media (e.g., a hard disk), optical media, memory devices (e.g., random access memory, flash memory), and the like. In some embodiments, the CRI 244 of computer program 243 is configured such that when executed by PC 202, the CRI causes device 200 to perform steps described herein (e.g., steps described herein with reference to the flow charts). In other embodiments, device 200 may be configured to perform steps described herein without the need for code. That is, for example, PC 202 may consist merely of one or more ASICs. Hence, the features of the embodiments described herein may be implemented in hardware and/or software.

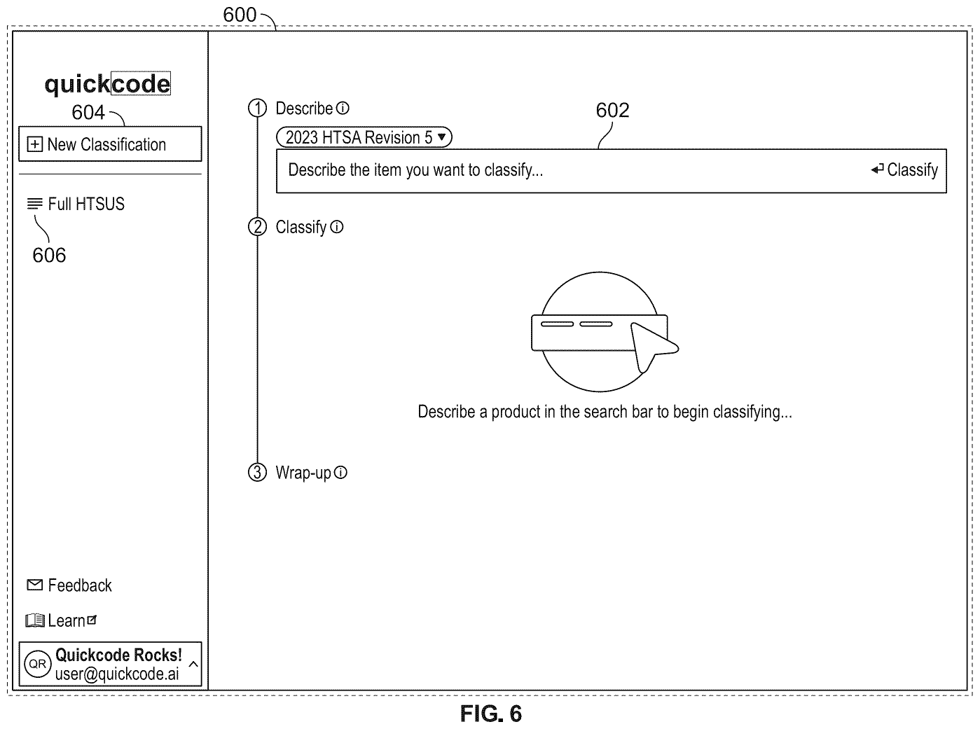

FIGS. 6-12 provide an illustrative example of an implementation of the process and flowcharts described above in a graphical user interface of a User Device 102, according to some embodiments.

Beginning with FIG. 6, a user may interact with the start screen of GUI 600 when beginning the classification process. GUI 600 may be displayed on a screen of User Devices 102A-B. GUI 600 comprises Description Text Box 602 where the user may enter a description of an object they wish to classify. In some embodiments, the user may use a description provided in an invoice of the object or create a description of the object themselves. On the left had side of GUI 600, the user may begin a new classification 604 or access a data source 606 such as the full HTSUS.

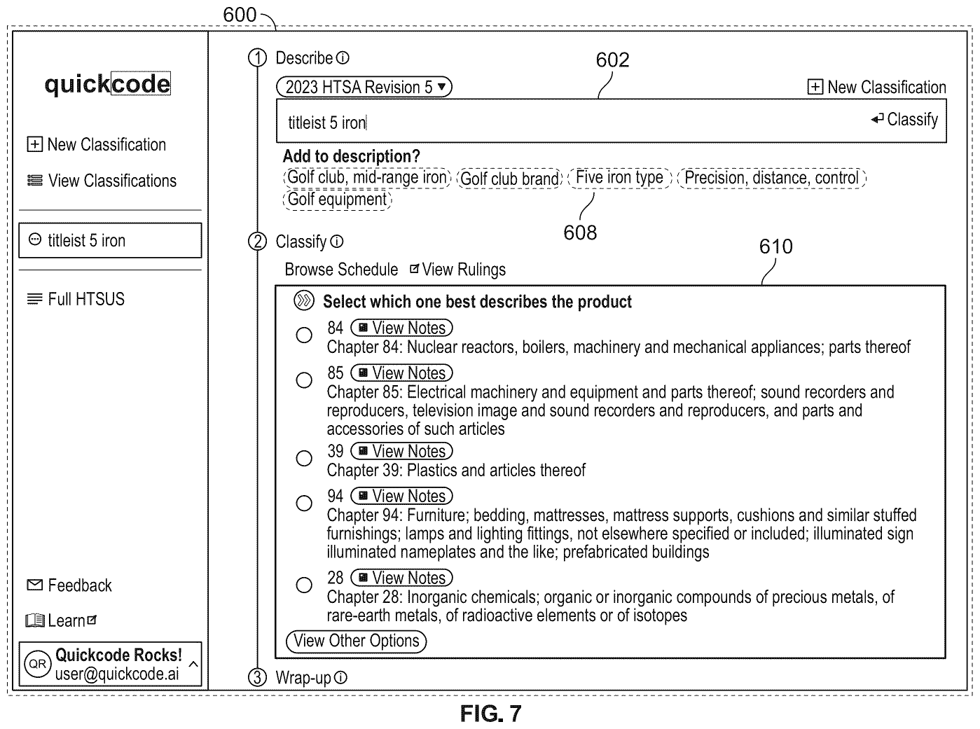

FIG. 7 illustrates GUI 600 after the user has entered the description of the object. In the present example, the user entered “titleist 5 iron” into Description Text Box 602. GUI 600 responsively displays Additional Descriptions 608. Additional Description 608 may be provided by First AI-Based Model 106. The user has the option to select one or more of the descriptions provided in Additional Description 608 to create an enhanced description. In the present example, First AI-Based Model 106 generated “Golf club brand,” “Five iron type,” and three other additional descriptions when “titleist 5 iron” was used with prompts provided by Server 104.

GUI 600 provides Potential Classifications 610 based on the description provided in Description Text Box 602. Potential Classifications 610 may be provided by Server 104 using Second AI-Based Model 110. Potential Classifications 610 provides the user with potential locations in the classification hierarchy system. This allows the user to select which options the user believes is relevant to the object. In the present example, the user may choose between locations of the classification system such as “Chapter 84: Nuclear reactors, boilers, machinery and mechanical appliances; parts thereof” and “Chapter 39: Plastics and articles thereof.” The user also has the option to “View Notes” for each of the presented locations and view other options.

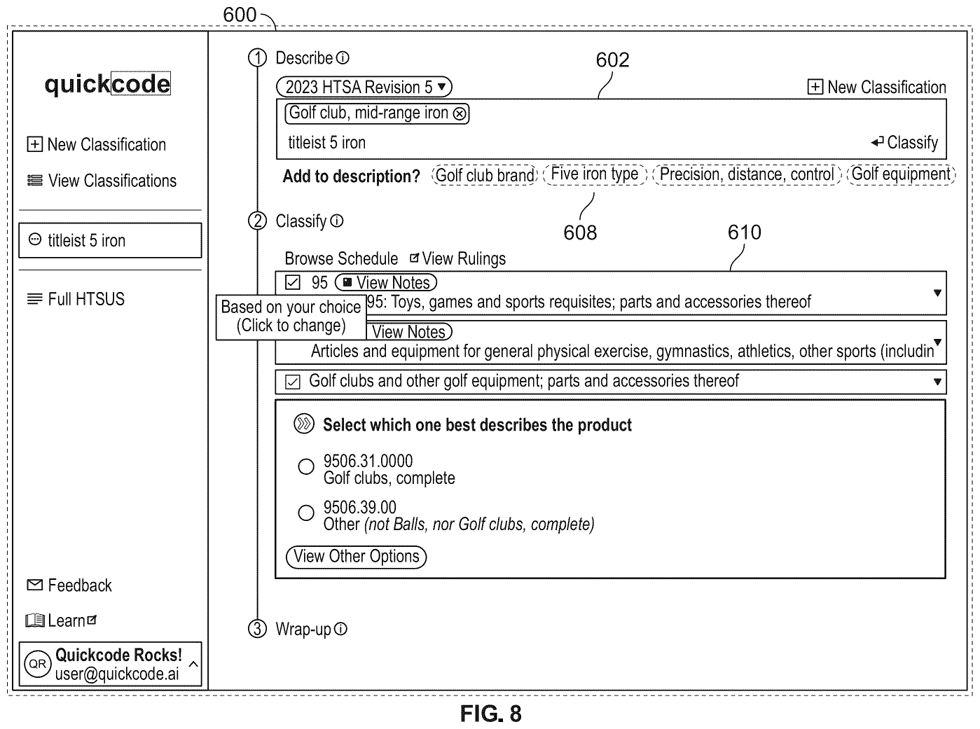

FIG. 8 illustrates GUI 600 after the user has selected an additional description and one or more of the potential classifications. When the user selects one or more of Additional Descriptions 608, Server 104 may input the selected additional description into Second AI-Based Model 110 and update Potential Classifications 610 based on the selected additional description.

In the present example, the user selected “Golf club, mid-range iron” from Additional Description 608. As a result, Potential Classifications 610 was populated with at least “Chapter 95: Toys, games and sports requisites; parts and accessories thereof.” The selected Additional Description 608 allowed Second AI-Based Model 110 to provide more accurate locations.

When the user selects a Potential Classifications 610 they believe accurately describes the object, GUI 600 updates Potential Classifications 610 by “drilling down” into the classification system. “Drilling down” being providing the user with the next level of classifications. As the user continues to “drill down” they will create a complete classification. In the present example, when the user selected Chapter 95, GUI 600 presented an updated Potential Classifications 610 which included heading 9506, which the user selected. Here, when heading 9506 was selected, the GUI presented an updated Potential Classifications 610 “drilling down” into heading 9506 by providing subheading 9506.31.0000 to “Golf clubs, complete” and 9506.39.00 to “Other (not Balls, nor Golf clubs, complete).

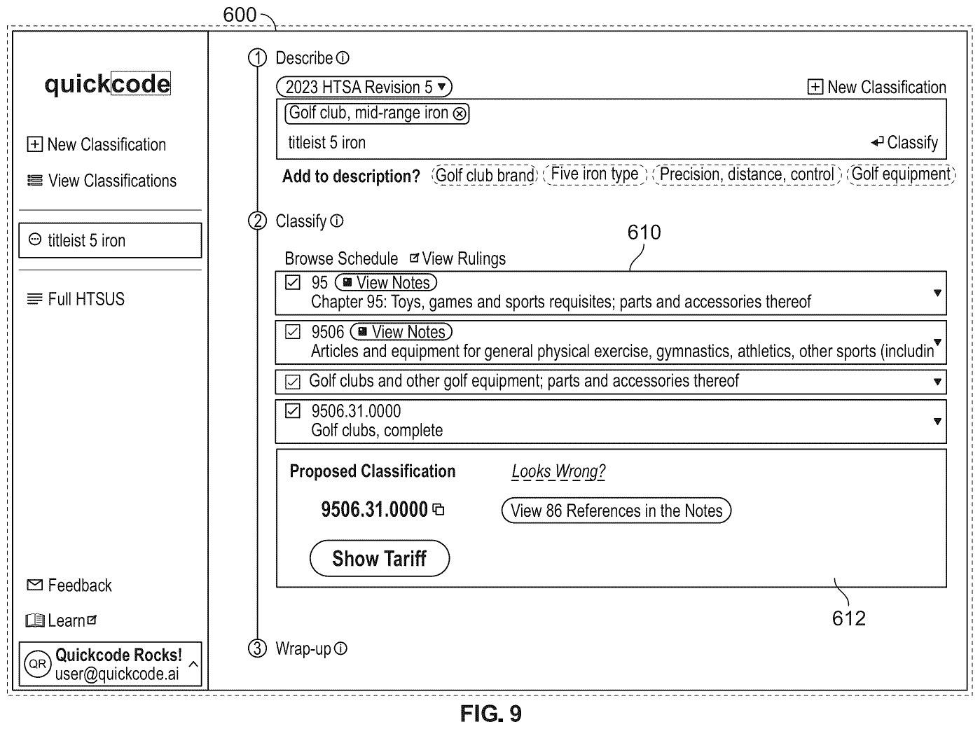

FIG. 9 illustrates GUI 600 after the user has selected a complete classification. With each user selection of Potential Classifications 610, GUI 600 will continue to “drill down” into the classification system until the user has selected a complete classification. Once a complete classification is selected, GUI 600 will present Additional Classification Information 612 to the user. Additional Classification Information 612 provides the user with the complete proposed classification, a link to view references, or data sources, associated with the proposed classification, and a tariff associated with the classification. In the present example, the user selected subheading 9506.31.0000 to “Golf clubs, complete” which is a complete classification.

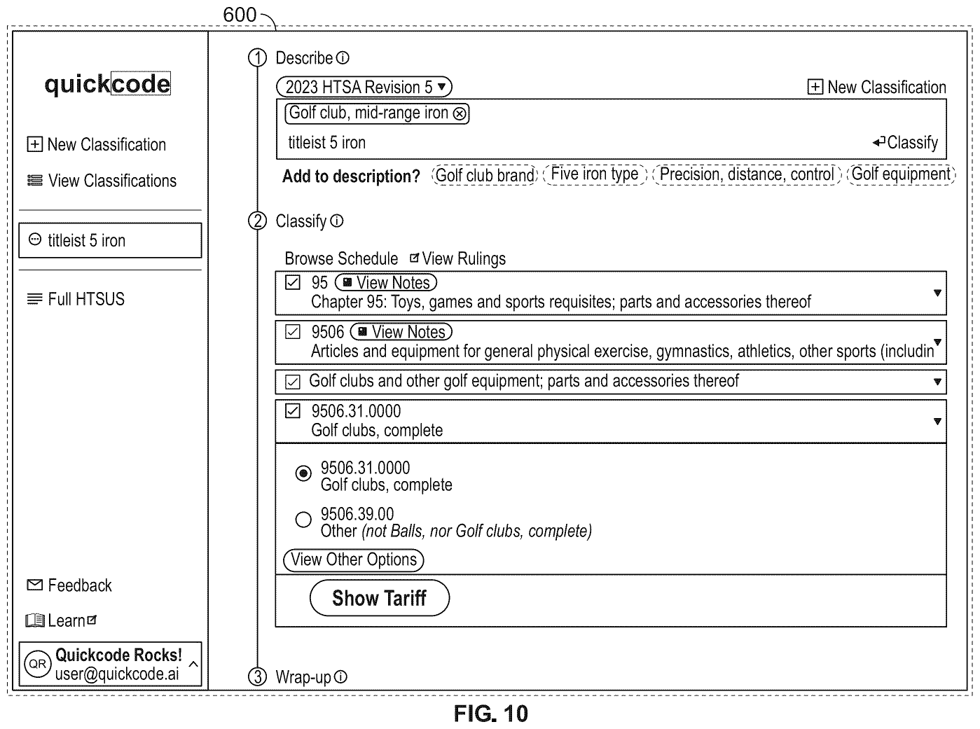

FIG. 10 illustrates GUI 600 when modifying the classification. GUI 600 allows the user to modify its selections during the classification process. The modification allows the user to “back track” and review the paths the user did not originally pursue. In the present example, the user may click on the selected “9506.31.0000” block to view the options he was previously presented with and may select a new option.

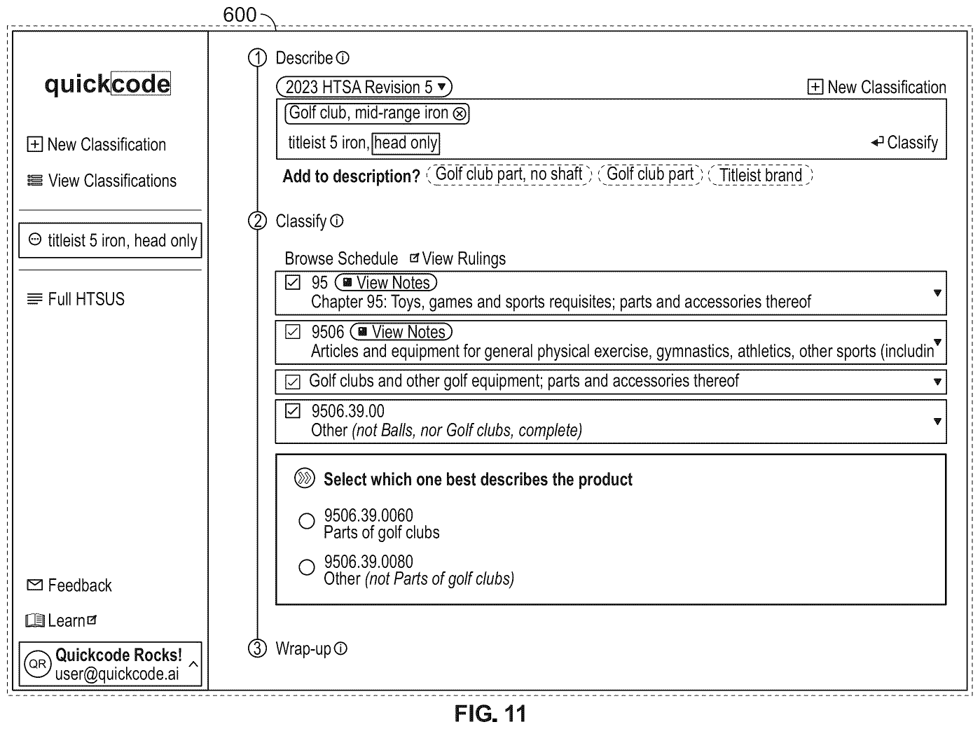

FIG. 11 illustrates the GUI 600 when modifying the classification suggestions. If the user selected the other option (such as “9506.39.00), GUI 600 will continue to present the User will location selections until a complete proposed classification is selected by the user. In the present example, the User selected “9506.39.00” from the options and is now presented with two additional option further drilling down into the classification system.

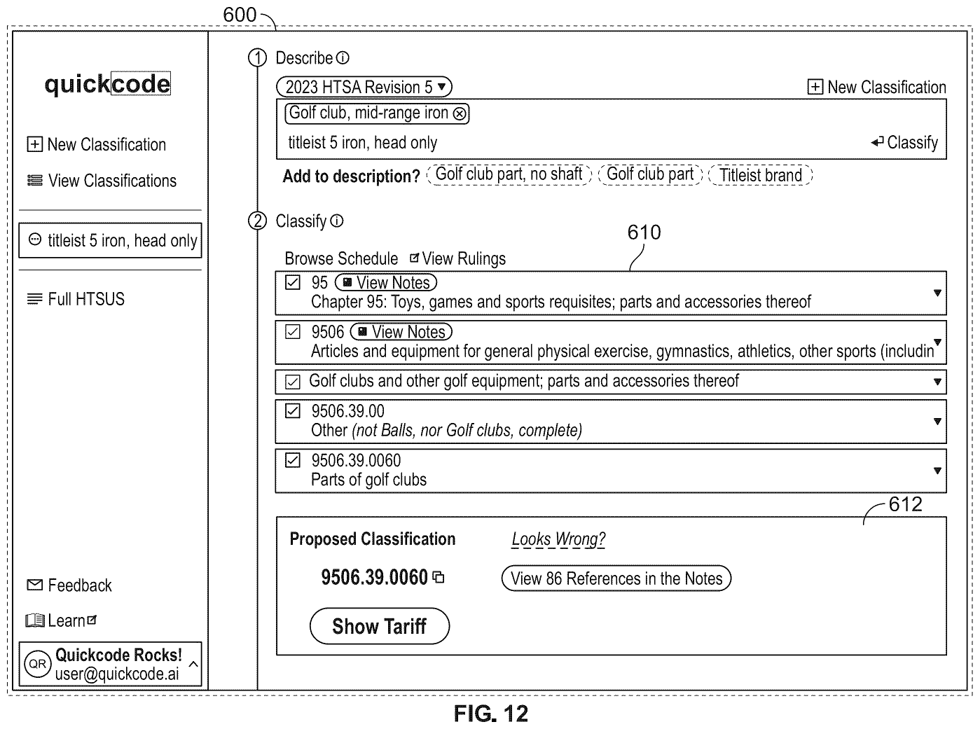

FIG. 12 illustrates GUI 600 when selecting a complete classification. In the present illustrative embodiment, the user selected “9506.39.0060,” a complete classification, from Proposed Classification 610. At this point, Additional Classification Information 612 reappears with information about the complete classification selected by the user.

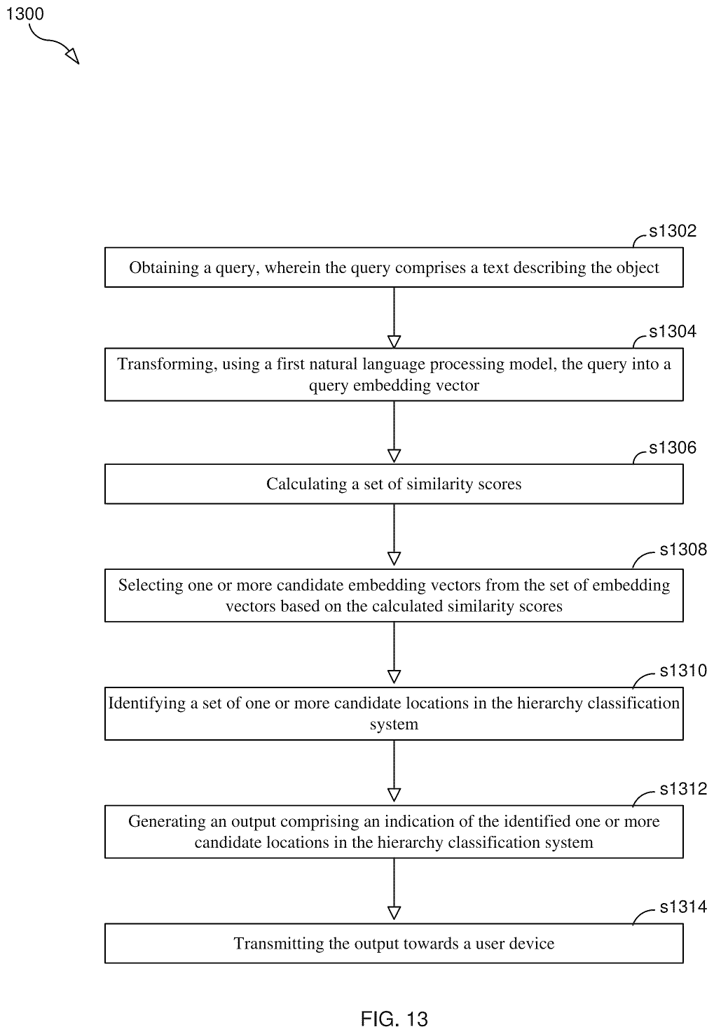

FIG. 13 is a method, according to some embodiments. The method 1300 involves a series of steps that may be performed by Architecture 100. In some embodiments, method 1300 is a computer-implemented method for classifying an object.

Step 1302 includes obtaining a query, wherein the query comprises a text describing the object.

Step 1304 includes transforming, using a first natural language processing model, the query into a query embedding vector.

Step 1306 includes calculating a set of similarity scores, wherein each similarity score in the set of similarity scores corresponds to a degree of similarity between the query embedding vector and an embedding vector in a set of embedding vectors, wherein each embedding vector in the set of embedding vectors is associated with a location in a hierarchy classification system and a data source of a plurality of data sources.

Step 1308 includes selecting one or more candidate embedding vectors from the set of embedding vectors based on the calculated similarity scores.

Step 1310 includes identifying a set of one or more candidate locations in the hierarchy classification system, wherein each of the one or more candidate locations is associated with at least one of the selected one or more candidate embedding vectors.

Step 1312 includes generating an output comprising an indication of the identified one or more candidate locations in the hierarchy classification system.

Step 1314 includes transmitting the output towards a user device.

In some embodiments, method 1300 further includes providing the text describing the object to a second natural language processing model; obtaining, from the second natural language processing model, an enhanced text describing the object, wherein the enhanced text comprises a second set of text; and updating the query with the enhanced text.

In some embodiments, the second natural language processing model comprises a large language model.

In some embodiments, the hierarchy classification system is The Harmonized Commodity Description and Coding System.

In some embodiments, the plurality of data sources comprise one or more of the Harmonized Traffic Schedule for the United States (HTSUS), World Customs Organization Explanatory Notes and Harmonized System, or a set of United States Customs Rulings.

In some embodiments, the first natural language processing model comprises a large language model trained to determine a similarity of meaning between the text describing the object and texts of the plurality of data sources.

In some embodiments, the method further includes receiving a candidate location selection transmitted by the user device; wherein the candidate location selection identifies a candidate location selected by the user; generating a secondary output comprising an indication of one or more candidate locations in the hierarchy classification system associated with the candidate location selection; transmitting the secondary output towards the user device.

In some embodiments, the method further includes receiving a candidate location selection transmitted by the user device; wherein the candidate location selection identifies a candidate location selected by the user; generating a secondary output comprising additional information associated with the candidate location selection; transmitting the secondary output towards the user device.

In some embodiments, the additional information comprises text from one of the plurality of data sources associated with the candidate location selection and/or tariff information associated with the candidate location selection.

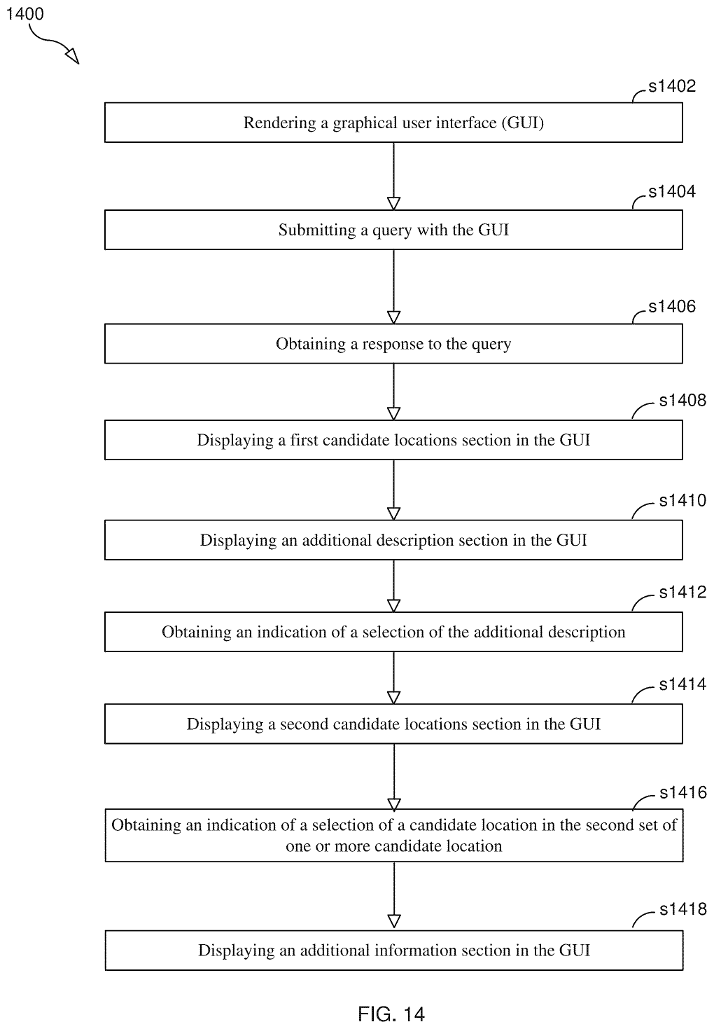

FIG. 14 is a method, according to some embodiments. The method 1400 involves a series of steps that may be performed by Architecture 100. In some embodiments, method 1400 is a computer-implemented method for classifying an object.

Step 1402 includes rendering a graphical user interface (GUI).

Step 1404 includes submitting a query with the GUI, wherein the query comprises a text describing the object.

Step 1406 includes obtaining a response to the query, the response comprising a first set of one or more candidate locations in a hierarchy classification system.

Step 1408 includes displaying a first candidate locations section in the GUI, the first candidate locations section identifying the first set of one or more candidate locations in the hierarchy classification system.

Step 1410 includes displaying an additional description section in the GUI, the additional description section identifying an additional description of the object based on the first set of one or more candidate locations.

Step 1412 includes obtaining an indication of a selection of the additional description.

Step 1414 includes displaying a second candidate locations section in the GUI, the second candidate locations section identifying a second set of one or more candidate locations in the hierarchy classification system based on the selection of the additional description.

Step 1416 includes obtaining an indication of a selection of a candidate location in the second set of one or more candidate location, wherein the selected candidate location is a complete classification in the hierarchy classification section.

Step 1418 includes displaying an additional information section in the GUI, the additional information section identifying additional information associated with the selected candidate location.

The following are certain enumerated embodiments further illustrating various aspects of the disclosed subject matter.

A1. A method for classifying an object, the method comprising:
obtaining a query, wherein the query comprises a text describing the object;
transforming, using a first natural language processing model, the query into a query embedding vector;
calculating a set of similarity scores, wherein each similarity score in the set of similarity scores corresponds to a degree of similarity between the query embedding vector and an embedding vector in a set of embedding vectors, wherein each embedding vector in the set of embedding vectors is associated with a location in a hierarchy classification system and a data source of a plurality of data sources;
selecting one or more candidate embedding vectors from the set of embedding vectors based on the calculated similarity scores;
identifying a set of one or more candidate locations in the hierarchy classification system, wherein each of the one or more candidate locations is associated with at least one of the selected one or more candidate embedding vectors;
generating an output comprising an indication of the identified one or more candidate locations in the hierarchy classification system; and
transmitting the output towards a user device.

A2. The method of embodiment A1, further comprising:
providing the text describing the object to a second natural language processing model;
obtaining, from the second natural language processing model, an enhanced text describing the object, wherein the enhanced text comprises a second set of text; and
updating the query with the enhanced text.

A3. The method of embodiment A2, wherein the second natural language processing model comprises a large language model.

A4. The method of any one of embodiments A1-A3, wherein the hierarchy classification system is The Harmonized Commodity Description and Coding System.

A5. The method of any one of embodiments A1-A4, wherein the plurality of data sources comprise one or more of the Harmonized Traffic Schedule for the United States (HTSUS), World Customs Organization Explanatory Notes and Harmonized System, or a set of United States Customs Rulings.

A6. The method of any one of embodiments A1-A5, wherein the first natural language processing model comprises a large language model trained to determine a similarity of meaning between the text describing the object and texts of the plurality of data sources.

A7. The method of any one of embodiments A1-A6, further comprising:
receiving a candidate location selection transmitted by the user device; wherein the candidate location selection identifies a candidate location selected by the user;
generating a secondary output comprising an indication of one or more candidate locations in the hierarchy classification system associated with the candidate location selection;
transmitting the secondary output towards the user device.

A8. The method of any one of embodiments A1-A6, further comprising:
receiving a candidate location selection transmitted by the user device; wherein the candidate location selection identifies a candidate location selected by the user;
generating a secondary output comprising additional information associated with the candidate location selection;
transmitting the secondary output towards the user device.

A9. The method of embodiment A8, wherein the additional information comprises text from one of the plurality of data sources associated with the candidate location selection and/or tariff information associated with the candidate location selection.

B1. A method for classifying an object, the method comprising:
rendering a graphical user interface (GUI);
submitting a query with the GUI, wherein the query comprises a text describing the object;
obtaining a response to the query, the response comprising a first set of one or more candidate locations in a hierarchy classification system;
displaying a first candidate locations section in the GUI, the first candidate locations section identifying the first set of one or more candidate locations in the hierarchy classification system;
displaying an additional description section in the GUI, the additional description section identifying an additional description of the object based on the first set of one or more candidate locations;
obtaining an indication of a selection of the additional description;
displaying a second candidate locations section in the GUI, the second candidate locations section identifying a second set of one or more candidate locations in the hierarchy classification system based on the selection of the additional description;
obtaining an indication of a selection of a candidate location in the second set of one or more candidate location, wherein the selected candidate location is a complete classification in the hierarchy classification section; and
displaying an additional information section in the GUI, the additional information section identifying additional information associated with the selected candidate location.

C1. A device adapted to perform any one of the methods in embodiments A1-A9 and B1.

D1. A computer program comprising instructions which when executed by processing circuity of a device causes the device to perform the method of any one of embodiments A1-A9 and B1.

While various embodiments of the present disclosure are described herein, it should be understood that they have been presented by way of example only, and not limitation. Thus, the breadth and scope of the present disclosure should not be limited by any of the above-described embodiments. Generally, all terms used herein are to be interpreted according to their ordinary meaning in the relevant technical field, unless a different meaning is clearly given and/or is implied from the context in which it is used. All references to a/an/the article, element, device, component, layer, means, step, etc. are to be interpreted openly as referring to at least one instance of the article, element, apparatus, component, layer, means, step, etc., unless explicitly stated otherwise. Any combination of the above-described elements in all possible variations thereof is encompassed by the disclosure unless otherwise indicated herein or otherwise clearly contradicted by context.

### REFERENCES

[1] HTSUS, https://hts.usitc.gov/

[2]Schedule B, https://www.census.gov/foreign-trade/schedules/b/index.html

[3] https://en.wikipedia.org/wiki/Harmonized_System

1. A method for classifying an object, the method comprising:
obtaining a query, wherein the query comprises a text describing the object;
transforming, using a first natural language processing model, the query into a query embedding vector;
calculating a set of similarity scores, wherein each similarity score in the set of similarity scores corresponds to a degree of similarity between the query embedding vector and an embedding vector in a set of embedding vectors, wherein each embedding vector in the set of embedding vectors is associated with a location in a hierarchy classification system and a data source of a plurality of data sources;
selecting one or more candidate embedding vectors from the set of embedding vectors based on the calculated similarity scores;
identifying a set of one or more candidate locations in the hierarchy classification system, wherein each of the one or more candidate locations is associated with at least one of the selected one or more candidate embedding vectors;
generating an output comprising an indication of the identified one or more candidate locations in the hierarchy classification system; and
transmitting the output towards a user device.

2. The method of claim 1, further comprising:
providing the text describing the object to a second natural language processing model;
obtaining, from the second natural language processing model, an enhanced text describing the object, wherein the enhanced text comprises a second set of text; and
updating the query with the enhanced text.

3. The method of claim 2, wherein the second natural language processing model comprises a large language model.

4. The method of claim 1, wherein the hierarchy classification system is The Harmonized Commodity Description and Coding System.

5. The method of claim 1, wherein the plurality of data sources comprise one or more of the Harmonized Traffic Schedule for the United States (HTSUS), World Customs Organization Explanatory Notes and Harmonized System, a set of United States Customs Rulings, or a list of human expert classifications.

6. The method of claim 1, wherein the first natural language processing model comprises a large language model trained to determine a similarity of meaning between the text describing the object and texts of the plurality of data sources.

7. The method of claim 1, further comprising:
receiving a candidate location selection transmitted by the user device; wherein the candidate location selection identifies a candidate location selected by the user;
generating a secondary output comprising an indication of one or more candidate locations in the hierarchy classification system associated with the candidate location selection;
transmitting the secondary output towards the user device.

8. The method of claim 1, further comprising:
receiving a candidate location selection transmitted by the user device; wherein the candidate location selection identifies a candidate location selected by the user;
generating a secondary output comprising additional information associated with the candidate location selection;
transmitting the secondary output towards the user device.

9. The method of claim 8, wherein the additional information comprises text from one of the plurality of data sources associated with the candidate location selection and/or tariff information associated with the candidate location selection.

10. The method of claim 1, further comprising:
prior to selecting the one or more candidate embedding vectors, selecting one or more initial candidate embedding vectors from the set of embedding vectors based on the calculated similarity scores;
providing the one or more initial candidate embedding vectors and their respective data sources to a third natural language processing model; and
obtaining, from the third natural language processing model, a second similarity score, wherein selecting the one or more candidate embedding vectors from the set of embedding vectors is further based on the second similarity score.

11. The method of claim 1, wherein the output further comprises an indication of a data source associated with the identified one or more candidate locations.

12. The method of claim 1, further comprising:
receiving a candidate location selection from the user device;
determining that a data source associated with the candidate location selection is modified; and
transmitting a modification update towards the user device.

13. The method of claim 1, further comprising:
calculating a confidence score associated with the set of one or more candidate locations;
determining that the confidence score is below a confidence threshold; and
in response to the determining, generating the output comprises including an indication that the identified one or more candidate locations was identified as a result of the confidence score being below the confidence threshold.

14. A method for classifying an object, the method comprising:
rendering a graphical user interface (GUI);
submitting a query with the GUI, wherein the query comprises a text describing the object;
obtaining a response to the query, the response comprising a first set of one or more candidate locations in a hierarchy classification system;
displaying a first candidate locations section in the GUI, the first candidate locations section identifying the first set of one or more candidate locations in the hierarchy classification system;
displaying an additional description section in the GUI, the additional description section identifying an additional description of the object based on the first set of one or more candidate locations;
obtaining an indication of a selection of the additional description;
displaying a second candidate locations section in the GUI, the second candidate locations section identifying a second set of one or more candidate locations in the hierarchy classification system based on the selection of the additional description;
obtaining an indication of a selection of a candidate location in the second set of one or more candidate location, wherein the selected candidate location is a complete classification in the hierarchy classification section; and
displaying an additional information section in the GUI, the additional information section identifying additional information associated with the selected candidate location.

15. A device comprising:
a memory; and
processing circuitry coupled to the memory, wherein the processing circuitry is adapted to:
obtain a query, wherein the query comprises a text describing the object;
transform, using a first natural language processing model, the query into a query embedding vector;
calculate a set of similarity scores, wherein each similarity score in the set of similarity scores corresponds to a degree of similarity between the query embedding vector and an embedding vector in a set of embedding vectors, wherein each embedding vector in the set of embedding vectors is associated with a location in a hierarchy classification system and a data source of a plurality of data sources;
select one or more candidate embedding vectors from the set of embedding vectors based on the calculated similarity scores;
identify a set of one or more candidate locations in the hierarchy classification system, wherein each of the one or more candidate locations is associated with at least one of the selected one or more candidate embedding vectors;
generate an output comprising an indication of the identified one or more candidate locations in the hierarchy classification system; and
transmit the output towards a user device.

16. A device comprising:
a memory; and
processing circuitry coupled to the memory, wherein the processing circuitry is adapted to:
render a graphical user interface (GUI);
submit a query with the GUI, wherein the query comprises a text describing the object;
obtain a response to the query, the response comprising a first set of one or more candidate locations in a hierarchy classification system;
display a first candidate locations section in the GUI, the first candidate locations section identifying the first set of one or more candidate locations in the hierarchy classification system;
display an additional description section in the GUI, the additional description section identifying an additional description of the object based on the first set of one or more candidate locations;
obtain an indication of a selection of the additional description;
display a second candidate locations section in the GUI, the second candidate locations section identifying a second set of one or more candidate locations in the hierarchy classification system based on the selection of the additional description;
obtain an indication of a selection of a candidate location in the second set of one or more candidate location, wherein the selected candidate location is a complete classification in the hierarchy classification section; and
display an additional information section in the GUI, the additional information section identifying additional information associated with the selected candidate location.
